(19) United States
(12) Patent Application Publication
(10) Pub. No.: US 2007/0164239 A1
(43) Pub. Date: Jul. 19, 2007

(54) Variable stop collimator

(75) Inventors: Rick A. Terwilliger, Venice, CA (US); L. Michael Cutrer, Chatsworth, CA (US)

Correspondence Address: MCDERMOTT WILL & EMERY LLP, 2049 CENTURY PARK EAST, 34TH FLOOR, LOS ANGELES, CA, 90067-3208, US

(73) Assignee: North American Scientific

(21) Appl. No.: 11/331,677

(22) Filed: Jan. 13, 2006

(51) Int. Cl. G21K 1/04

(52) U.S. Cl. 250/505.1

(57) ABSTRACT

A variable stop collimator for use in a radiation therapy machine having a radiation source for producing a radiation beam directed toward a patient. The variable stop collimator includes a plurality of radiation attenuating leaves, with each leaf having an opposing leaf to collimate a ray of the radiation beam. For each leaf, the collimator includes a pneumatic cylinder configured to independently move each leaf between the open and closed state and at points between the open and closed states. Each pneumatic cylinder is connected at one end to the leaf and, at the other end, to a variable stop. The stop may include a raised spiral projection that permits a smooth stop at any point deemed appropriate for the motor. The collimator includes a support configured to guide the plurality of radiation attenuating leaves transverse to the beam plane.

### BACKGROUND

1. Field

The present disclosure relates to radiation treatment for tumors and, more particularly, to a collimator that more precisely focuses a radiation source via partially opening a radiation attenuating leaf.

2. Description of Related Art

Radiation therapy is a common treatment option for patients with tumors. Collimators are commonly used to define a radiation beam used to irradiate tumors. Because radiation therapy is focused on treating the tumor and not destroying healthy tissue, it is highly desirable that the radiation beam is focused to define an exact point of radiation and with a high degree of accuracy. A significant number of tumors tend to have irregular contours. Collimators have been used to assist in defining exact points of radiation for such irregularly defined tumors, as well as tumors having more conventionally-recognized shapes.

A very important aspect of a collimator is its leaves. With some of today's collimators, one or more leaves are configured so that they may be either fully open or fully shut. Generally, the leaves are positioned so that they may direct a radiation beam onto a portion of a tumor to be irradiated. When a particular leaf is open, the radiation beam is permitted to pass through the leaves. When a particular leaf is shut, the converse is true. That is, the radiation beam is not permitted to pass through the radiopaque leaf. This function is largely because a leaf may be composed of a radiopaque material such as tungsten.

Devices incorporating such an open and shut configuration require time for the leaves to implement these motions, thus resulting in longer treatment times which may be expensive for the patient and uncomfortable since the patient must remain in an immobilized state.

There is a need for a collimator that precisely focuses a radiation beam with less discomfort and associated expense.

### BRIEF SUMMARY

The present disclosure addresses the foregoing deficiencies of the prior art by providing an apparatus to more precisely focus a radiation source via partially opening or closing a leaf to vary the shape of the radiation beam that is directed onto a patient.

In accordance with one embodiment of the present disclosure, a variable stop collimator is provided for use in a radiation therapy machine having a radiation source for producing a radiation beam plane directed toward a patient. The variable stop collimator comprises a plurality of radiation attenuating leaves. For each leaf, a pneumatic cylinder is operably coupled thereto, the pneumatic cylinder being configured to independently move each leaf. A variable stop mechanism is operably coupled to each pneumatic cylinder, the variable stop mechanism being configured to move the cylinder such that it causes a coupled leaf to move transverse to the beam plane at points between an open and closed state. The collimator further includes a motor coupled to each variable stop mechanism, the motor being configured to control each variable stop mechanism.

In accordance with another embodiment of the present disclosure, a variable stop collimator is provided for use in a radiation therapy machine having a radiation source for producing a radiation beam plane directed toward a patient. The variable stop collimator comprises a plurality of radiation attenuating leaves. Each leaf of said plurality of leaves is positioned substantially opposite to another leaf. For each leaf, a pneumatic cylinder is operably coupled thereto, the pneumatic cylinder being configured to independently move each leaf. The collimator further includes a variable stop mechanism operably coupled to each pneumatic cylinder, the variable stop mechanism being configured to move the cylinder such that it causes a coupled leaf to move transverse to the beam plane between an open and closed state, and at points between the open and closed state. The collimator further includes a motor coupled to each variable stop mechanism, the motor being configured to control each variable stop mechanism.

In accordance with another embodiment of the present disclosure, a variable stop collimator is provided for use in a radiation therapy machine having a radiation source for producing a radiation beam plane directed toward a patient. The variable stop collimator comprises a plurality of radiation attenuating leaves. For each leaf, a pneumatic cylinder is operably coupled thereto, the pneumatic cylinder being configured to independently move each leaf. The collimator further includes a variable stop mechanism operably coupled to each pneumatic cylinder, the variable stop mechanism being configured to move the cylinder such that it causes a coupled leaf to move transverse to the beam plane between an open and closed state, and at points between the open and closed state. The variable stop mechanism includes a substantially cylindrical base and a raised member. The collimator further includes a motor coupled to each variable stop mechanism, the motor being configured to control each variable stop mechanism.

These, as well as other objects, features and benefits will now become clear from a review of the following detailed description of illustrative embodiments and the accompanying drawings.

### BRIEF DESCRIPTION OF DRAWINGS

FIG. 1A is a view of collimator elements with a leaf in its fully extended or fully closed state.

FIG. 1B is a view of the collimator elements of FIG. 1A, but with the leaf having been retracting approximately halfway and in a partially open state.

FIG. 1C is a view of the collimator elements of FIG. 1B, with the leaf being fully retracted or in a fully open state.

FIG. 2 is a partially cutaway view of a plurality of collimator elements as they would be positioned generally in the collimator.

FIG. 3A is a representation of two sets of opposing leaves and an example of a shape formation that can be accomplished using these leaves.

FIG. 3B is a representation of the two sets of opposing leaves of FIG. 3A in another shape formation.

FIG. 3C is a representation of the two sets of opposing leaves of FIG. 3B in yet another shape formation.

FIG. 4 is a radiation treatment table in which the collimator may reside.

FIGS. 5A, 5B illustrate another embodiment of a variable stop mechanism in accordance with the present disclosure.

FIGS. 6A-6D illustrated a simplified partial cutaway view of a variable stop mechanism in accordance with one embodiment of the present disclosure.

### DETAILED DESCRIPTION OF ILLUSTRATIVE EMBODIMENTS

The present disclosure is directed to a variable stop collimator. The collimator incorporates a motor having a spiral stop positioned on the motor's shaft. The spiral stop mechanically controls the positioning of a pneumatic cylinder used to drive a leaf of the collimator. The leaves may be either fully or partially open to permit a radiation beam or its beam plane to pass therethrough. The collimator permits a precise beam to be defined, while also allowing--via one or more motion sensors--for adjustment of this precise beam to account for the patient's breathing.

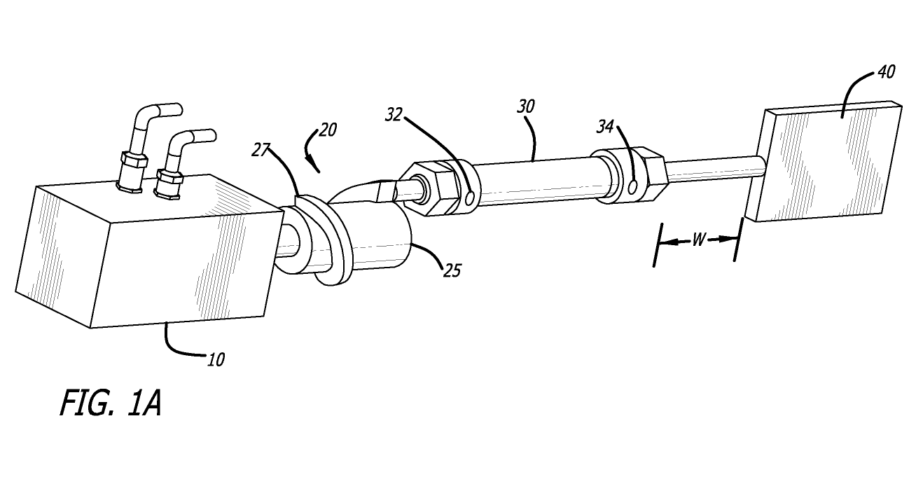

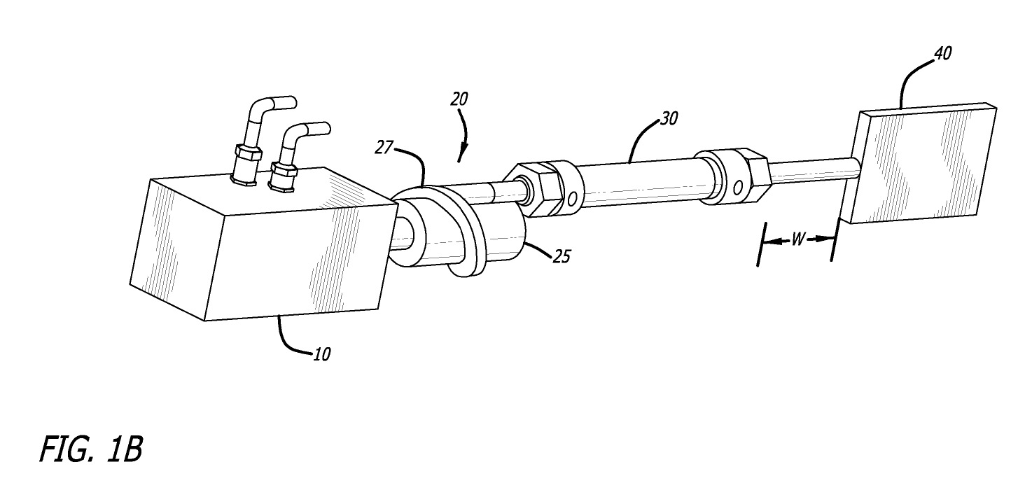

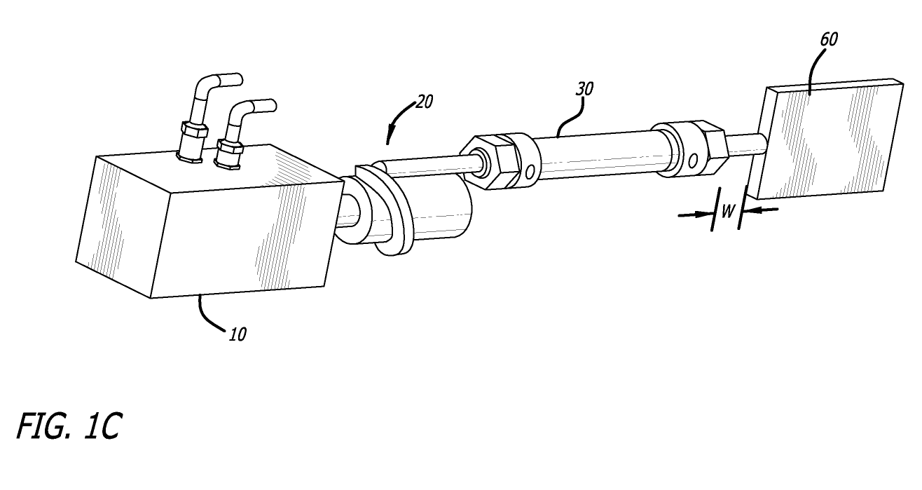

Referring now to FIG. 1A, illustrated is a collimator having a leaf in its fully closed position in accordance with one embodiment of the present disclosure. The collimator may include twenty (20) to forty (40) of the combination of elements shown in FIG. 1A. The combination includes a motor 10, the shaft of which is coupled to substantially the central axis of a variable stop 20. It should be noted that the motor 10 powers the variable stop 20 and not the pneumatic cylinder 30. One or more compressors may operate to drive the pneumatic cylinder 30. The variable stop 20 has a substantially cylindrical base 25 with a raised spiral component 27 that winds around the cylindrical base 25.

When the motor 10 is operable, the motor 10 turns the shaft which, in turn, rotates the variable stop 20 around the axis of the substantially cylindrical base 25. A pneumatic drive air cylinder 30 is positioned at one end on the variable stop 20 so that, depending upon the portion of the raised spiral component 27 on which the cylinder 30 rests, cylinder 30 may control the leaf 40 at the other end so that the leaf 40 may be partially open, completely open or completely shut. Air could be supplied to cylinder via openings 32, 34.

As indicated, the leaf of the FIG. 1A is fully extended and is thus, in a fully closed state, as indicated by the notation. The radiation source (not shown) would beam from above the leaf 40. As will be shown in more detail hereinbelow, the radiation beam is not permitted to pass through the radiopaque leaf. This function is largely because a leaf may be composed of a radiopaque material such as tungsten. Unlike collimators having only fully open or fully closed positions, using the collimator of the present disclosure, a radiation beam may be more finely tuned to irradiate tumors.

A motion sensor (not shown) may be coupled to the patient in order to track the patient's breathing. The motion sensor should, in turn, be coupled to operational apparatuses for the collimator that assist with the collimator's radiation therapy planning. In this manner, each leaf of the collimator may be re-positioned according to the patient's breathing, thus adjusting the centerline of the beam to more accurately irradiate the tumor and avoid healthy tissue.

Referring now to FIG. 1B, illustrated are the collimator elements of FIG. 1A, but with the leaf having been retracted approximately halfway. As shown, the width (w) has become much smaller than in FIG. 1A. When the leaf 40 is retracted in such a manner, a radiation source would be permitted to pass through the open portion of leaf 40 and onto a patient. The leaf has been retracted because variable stop 20 permits positioning of the shaft of cylinder 30 closer to the end where the motor 10 is located.

Referring now to FIG. 1C, illustrated are the collimator elements of FIG. 1B, but with the leaf having been fully retracted. As shown, the width (w) has become smaller than in FIG. 1B. When the leave is fully retracted in such a manner, the beam plane from a radiation source that comes from above the leaf would be permitted to pass through the space the radiopaque leaf had filled.

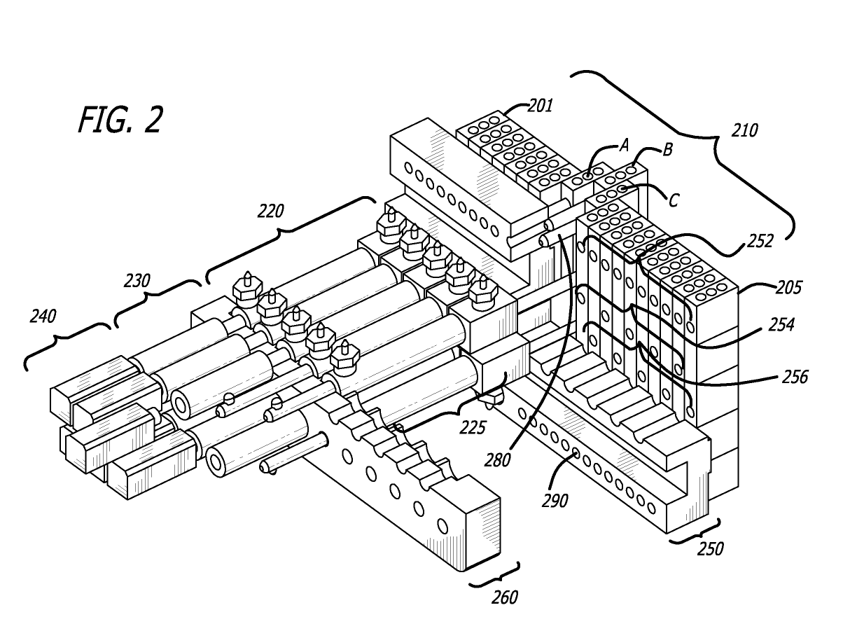

Referring now to FIG. 2, illustrated is a partially cutaway view of collimator elements as they would be positioned generally in the collimator. As shown in FIG. 2, the collimator elements include a plurality of radiation attenuating leaves 210. The number of leaves 210 in this particular embodiment is twenty (20). It should be noted that what is shown is only half of the collimator elements. A substantially mirror image would be formed of what is shown to provide a second set of collimator elements with a second set of leaves substantially opposite the first set of twenty (20) leaves shown, for a total of forty (40) radiation attenuating leaves.

A beam originating from a radiation source would emit rays through the radiation attenuating leaves 210. The beam plane would be substantially the same width as the leaves 210, traversing the span of the leaves 210 from a first point 205 to a second point 207, the beam plane being as wide as the two rows of leaves. As shown in FIG. 2, leaves referenced as leaves A, B and C are partially closed as shown by their extension into the beam plane, while the remaining leaves are open as shown by their retraction from the beam plane. A radiation therapy plan may call for leaves, e.g., A, B and C, to be partially closed to block the radiation source to avoid healthy tissue from being exposed to radiation.

Two rows of pneumatic cylinders, including a first or upper row of pneumatic cylinders 220 and a second or lower row of pneumatic cylinders may be used to drive the leaves. Each one of the leaves 210 is connected to a shaft of one of the first row of pneumatic cylinders 220 or the second row of pneumatic cylinders 225.

A first support 250 is positioned between the pneumatic cylinders 220, 225 and leaves 210 to provide support for the shafts of pneumatic cylinders 220, 225 and leaves 210. As illustrated in this partially cutaway view, a first row of openings 254 may be used to insert the shafts of the first row of pneumatic cylinders 220. Likewise, a second row of openings 256 may be used to insert the shafts of the second row of pneumatic cylinders 256. The shafts would be positioned through openings in the first support 250.

Since the pneumatic cylinders 220, 225 may have a substantial height, guide rods, e.g., 280 may be inserted into leaves 210 through openings, e.g., openings 252. Another row of guide rods (not shown) may be present at the interior of areas, e.g., 290, to further assist with positioning and guiding the pneumatic cylinders 220, 225 into place.

For each leaf and pneumatic cylinder, the collimator elements would also include variable stops or cams 230 and motors 240. A second support 260 may be positioned between the pneumatic cylinders 220 and variable stops 230. This second support 260 may have openings through which shafts of the pneumatic cylinders 220, 225 may be inserted. Variable stops or cams 230 may be positioned and connected to the other end of the shafts of pneumatic cylinders 220, 225. As shown, first support includes two rows on supports for these shafts at the other end of pneumatic cylinders 220, 225.

As earlier described, the variable stops 230 may include a raised spiral projection that permits positioning of a pneumatic cylinder shaft at various positions, from retracted to partially extended to fully extended.

Motors 240 or other driving mechanisms should have sufficient power to drive the variable stops 230 in ways that are known in the art. However, it should be understood that the motors do not power the cylinders 220, 225.

As indicated, each leaf has an opposing leaf which permits the leaves to form a variety of shapes so as to conform to irregular tumor shapes.

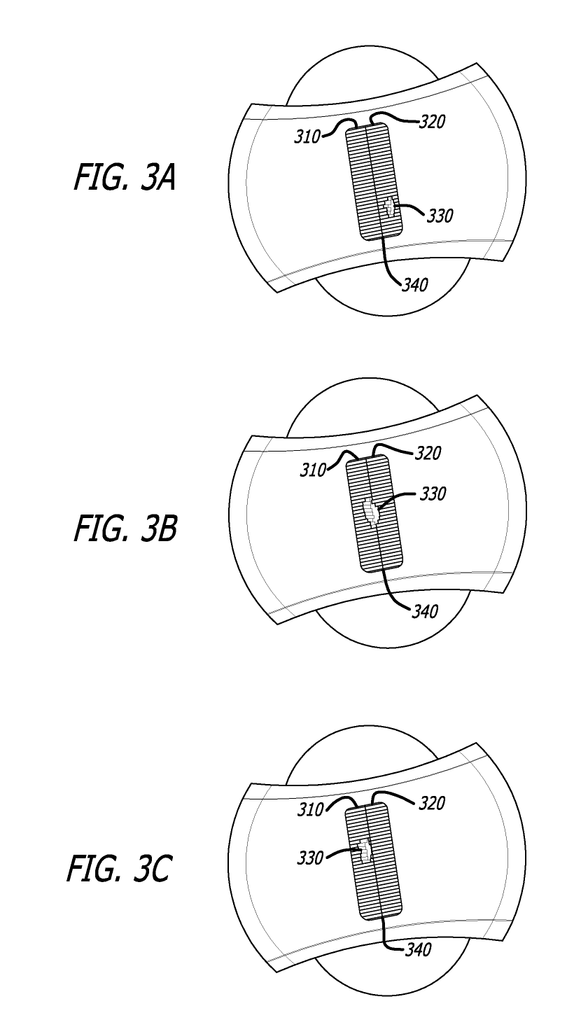

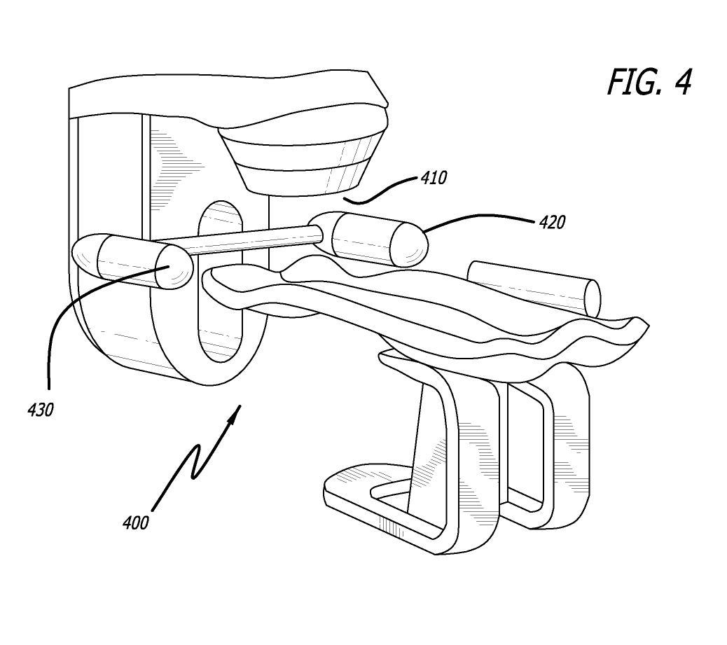

Referring now to FIG. 3A, illustrated is a representation of two sets of opposing leaves and an example of a shape formation that can be accomplished using these leaves. As shown in FIG. 3A, two sets of opposing leaves 310, 320 can be used to form an aperture 330 of irregular shape. As shown, the shape may be formed to the right of the line 340 between the two sets of opposing leaves 310, 320. This is because any single leaf may be configured to extend beyond the line 340 between the two sets of opposing leaves 310, 320.

Referring now to FIG. 3B, illustrated is a representation of the two sets of opposing leaves of FIG. 3A in another shape formation. As illustrated, an aperture 330 has been created just to the left of the line 340 between the two sets of opposing leaves 310, 320.

Referring now to FIG. 3C, illustrated is a representation of the two sets of opposing leaves in yet another shape formation. As shown, the two sets of opposing leaves 310, 320 have created an aperture 330 farther to the left of the line 340 than in FIG. 3B.

In addition, the two sets of opposing leaves may conform to more conventional shapes, e.g., substantially circular or elliptical, square or rectangular, just to name a few.

In radiation therapy, the physician generally must locate the target in a precise manner so as to avoid irradiating healthy tissue. Locating the target may include determining the size, location, shape and proximity to organs and other tissue. Diagnostic procedures such as computerized tomography (CT) scans and magnetic resonance imaging (MRI) may be used to assist the physician in determining the tumor's location.

Referring now to FIG. 4, illustrated is a radiation treatment table 400 on which the collimator may reside. Imaging devices 420, 430 may be used in conjunction with CT scans and MRI's to determine the tumor's location. The tumor's location may be identified according to a set of x, y and z coordinates or other known means of identifying the location of tumors. Once the tumor has been located, the patient should be held still (or at least the tumor area that has been identified).

The patient or target area may be held still by adding straps to the table 400 or by using other immobilization devices such as stereotactic head frames. Some of these items may be custom made from plastic for each particular patient. Immobilization is especially important for smaller tumors since a small movement may cause the target to move, thus increasing the risk of damage to healthy tissue or vital organs.

The patient must be properly aligned so that the radiation may be properly aimed at target areas. Various techniques may then be used to determine proper positioning of the patient, including, but not limited to, X-ray markers, infrared cameras and skin markers. Using these techniques, the patient's body may be matched to a radiation therapy plan that might have been previously developed with the aid of software. The software may determine the precise location of the tumor and this location may be matched to the patient's current position.

The radiation treatment machine should be aligned with the patient so that a precise beam of radiation may be passed from the machine to the patient. The collimator assists with producing this precise beam and may reside in collimator area 410 just above the patient and may be bolted to the linear accelerator (LINAC). A LINAC's radiation beam may be aimed at the target from various directions by rotating the machine and moving the treatment table 400.

Using a combination of software, e.g., radiation therapy planning software, and hardware, e.g., the collimator, as well as gating mechanisms to gate the patient's breathing, the radiation beam may aim more precisely at the target, thus avoiding healthy tissue.

In the present embodiment the collimator is implemented in an environment using external beam radiation that may be delivered from outside the body to aim high-energy rays, including x-rays, gamma rays or photons.

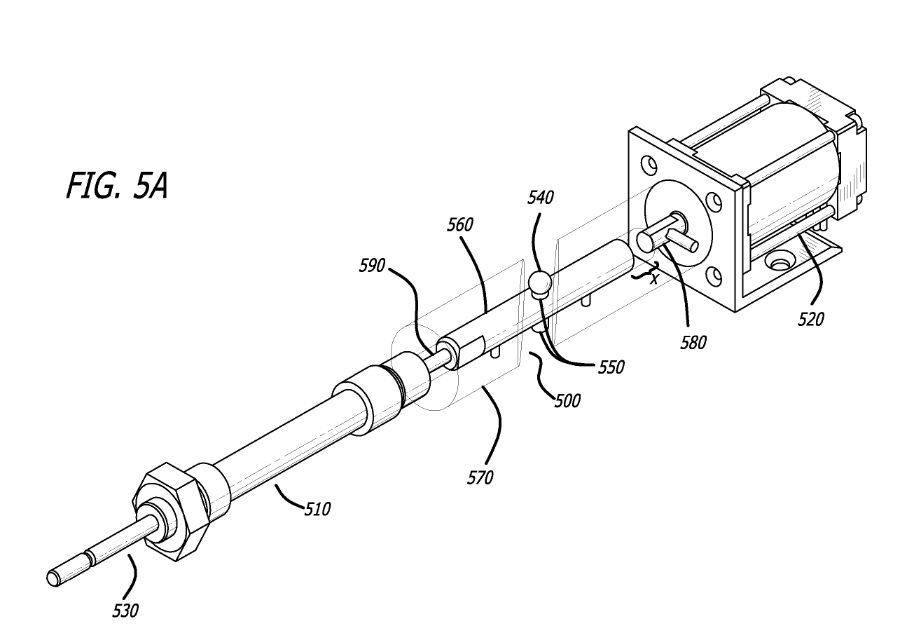

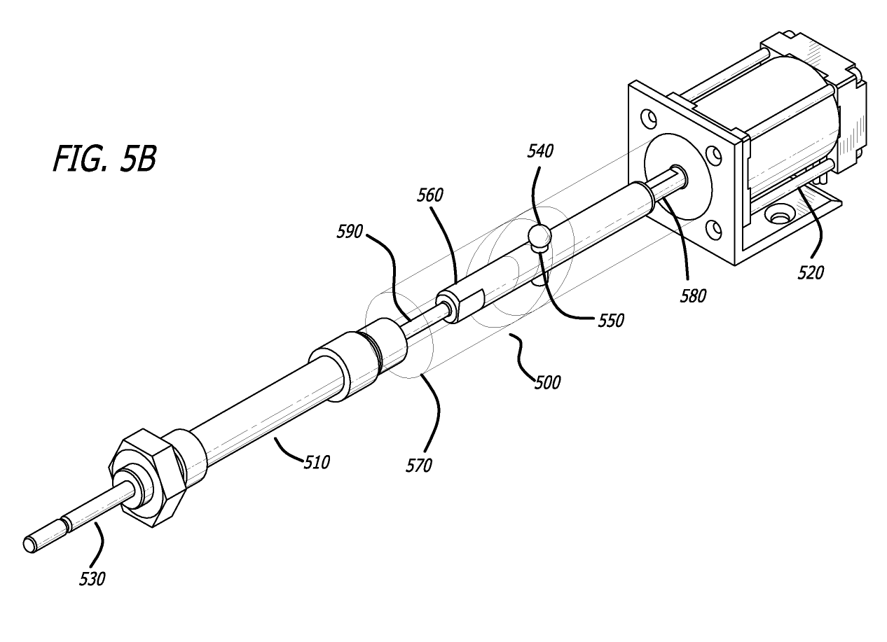

The variable stop mechanism in the collimator provides the ability to more accurately treat tissue with radiation. The variable stop mechanism could be implemented in a number of ways. Referring now to FIG. 5A, illustrated is another embodiment of a variable stop mechanism and accompanying components in accordance with the present disclosure.

As illustrated, the variable stop mechanism 500 may be mounted between pneumatic cylinder 510 and motor 520. The pneumatic cylinder 510 may be coupled to shaft 530 at one end. Shaft 530 may be coupled to a leaf that opens--partially or otherwise--to allow a high energy ray to be directed therethrough and onto a patient for purposes of radiation treatment. The extent to which the leaves are open or shut to allow a ray of light to beam therethrough may be dependent upon the position of the variable stop mechanism 500.

The variable stop mechanism 500 includes a substantially circular structure 540. Structure 540 may be integrally formed with a substantially tubular structure 550. Substantially tubular structure 540 may be embeddedly attached to substantially cylindrical rod 560. Substantially cylindrical rod 560 may be encased in support structure 570. Support structure 570 may include a channel disposed therethrough to permit movement of the substantially cylindrical rod 560.

The motion of substantially cylindrical rod 560 of variable stop mechanism 500 may be stopped by motor 520 to hold the position of a leaf that may be connected at the front end to shaft 530. In the illustrative embodiment of FIG. 5A, the shaft 530 is fully extended. Also as shown in FIG. 5A, motor 520 is not currently positioned to stop the substantially cylindrical rod 560 in this figure. As illustrated, the motor 520 has a shaft 580 that is positioned at a distance “x” away from the substantially cylindrical rod 560. Because the shaft 580 is not in contact with substantially cylindrical rod 560 of variable stop mechanism 500, the variable stop mechanism moves substantially in coordination with pneumatic cylinder via a shaft 590 disposed between the pneumatic cylinder 510 and the substantially cylindrical rod 560.

Referring now to FIG. 5B, illustrated is the variable stop mechanism of FIG. 5A and its accompanying components after the motor has stopped the variable stop mechanism. In accordance with the prior FIG. 5A, the shaft 580 of motor 520 was separated from the substantially cylindrical rod 580 via a distance “x”. As currently illustrated, the shaft 580 of motor 520 is now positioned directly against the substantially cylindrical rod 580, thus allowing the motor 520 to stop the position of the substantially cylindrical rod 580 of variable stop mechanism 500. When the variable stop mechanism 500 has been stopped, it allows the position of shaft 530-via its connection to pneumatic cylinder which is, in turn, connected to shaft 590-to be in a more retracted position. The degree to which the shaft 530 is retracted is controlled by its indirect coupling to variable stop mechanism 500.

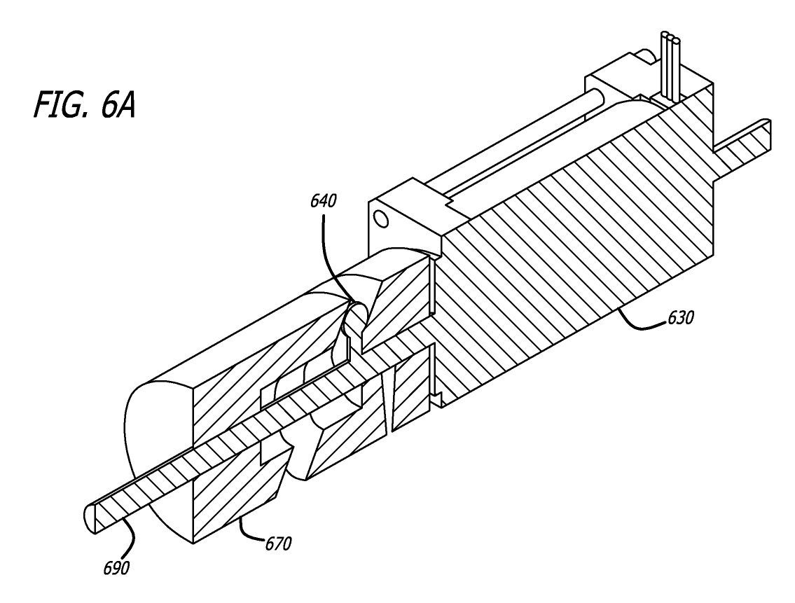

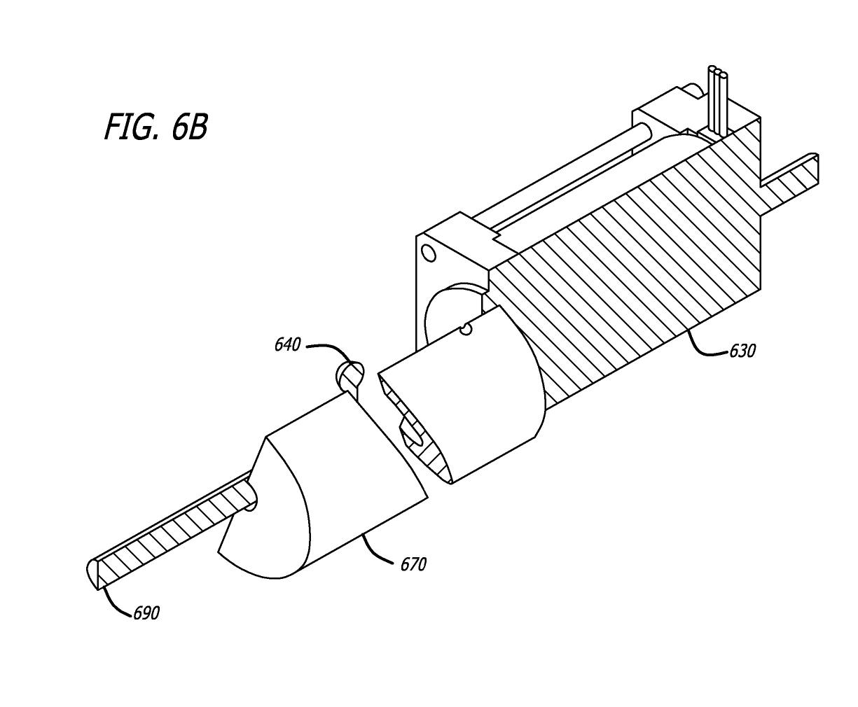

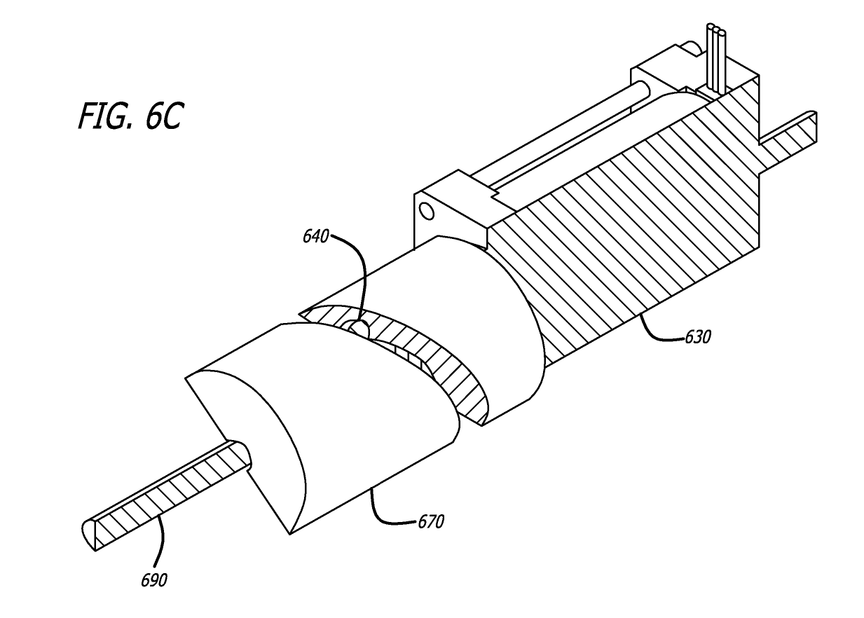

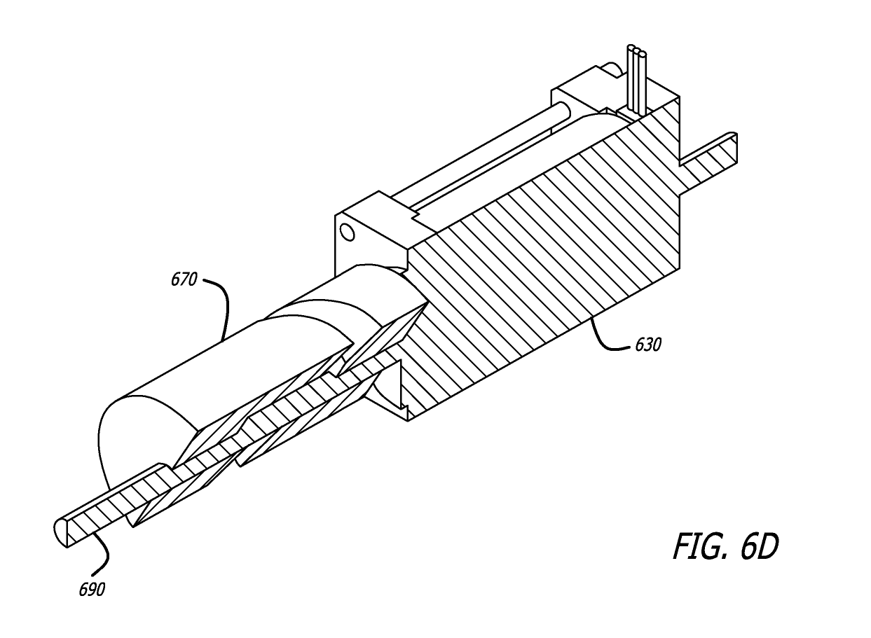

Referring now to FIG. 6A, illustrated is a simplified partial cutaway view of a variable stop mechanism in accordance with one embodiment of the present disclosure. As illustrated, the variable stop mechanism may be coupled to motor 630 via substantially cylindrical rod 690. Substantially circular structure 640 is integrally formed with substantially cylindrical rod 690. Guide structure 670 permits the positioning of substantially circular structure within guide structure 670 to extend or retract shaft 690. Of course, shaft 690 would have disposed on its front end, a leaf that could be partially opened, fully opened or shut depending on the position of shaft 690.

Referring now to FIG. 6B, the guide structure 670 has been repositioned so as to further extend the position of shaft 690.

Referring now to FIG. 6C, the guide structure 670 has been repositioned so that shaft is further retracted. As shown, the substantially circular structure 640 is moving nearer motor 630 along the opening in guide structure 670.

Referring now to FIG. 6D, the guide structure 670 has been repositioned closer to motor 630 so that the shaft 690 is still further retracted. As can be envisioned by one of ordinary skill in the art, many variations of the variable stop mechanism are possible.

While the specification describes particular embodiments of the present invention, those of ordinary skill can devise variations of the present invention without departing from the inventive concept.

We claim:

1. In a radiation therapy machine having a radiation source for producing a radiation beam plane directed toward a patient, a variable stop collimator comprising:
a plurality of radiation attenuating leaves;
for each leaf, a pneumatic cylinder operably coupled thereto, the pneumatic cylinder being configured to independently move each leaf;
a variable stop mechanism operably coupled to each pneumatic cylinder, the variable stop mechanism being configured to move the cylinder such that it causes a coupled leaf to move transverse to the beam plane at points between an open and closed state; and
a motor coupled to each variable stop mechanism, the motor being configured to control each variable stop mechanism.

2. The variable stop collimator of claim 1, further comprising:
a gate mechanism configured to gate a patient's movement, and to adjust the collimator; and
an adjustment mechanism configured to adjust a centerline of the beam plane according to the patient's movement.

3. The variable stop collimator of claim 2, wherein the gate mechanism includes a motion sensor.

4. The variable stop collimator of claim 1, wherein the radiation therapy machine is a LINAC.

5. The variable stop collimator of claim 1, wherein the variable stop includes a substantially cylindrical base having a raised spiral projection.

6. The variable stop collimator of claim 1, wherein the number of the plurality of radiation attenuating leaves is forty.

7. The variable stop collimator of claim 1, wherein the variable stop mechanism includes:
a substantially cylindrical base;
a raised member fixedly attached to the base;
a guide structure configured to guide the raised member along a curved path.

8. In a radiation therapy machine having a radiation source for producing a radiation beam plane directed toward a patient, a variable stop collimator comprising:
a plurality of radiation attenuating leaves, each leaf of said plurality of leaves being positioned substantially opposite to another leaf;
for each leaf, a pneumatic cylinder operably coupled thereto, the pneumatic cylinder being configured to independently move each leaf;
a variable stop mechanism operably coupled to each pneumatic cylinder, the variable stop mechanism being configured to move the cylinder such that it causes a coupled leaf to move between an open and closed state, and at points between the open and closed state; and
a motor coupled to each variable stop mechanism, the motor being configured to control each variable stop mechanism.

9. The variable stop collimator of claim 8, further comprising:
a gate mechanism configured to gate a patient's movement, and to adjust the collimator; and
an adjustment mechanism configured to adjust a centerline of the beam plane according to the patient's movement.

10. The variable stop collimator of claim 9, wherein the gate mechanism includes a motion sensor.

11. The variable stop collimator of claim 8, wherein the radiation therapy machine is a LINAC.

12. The variable stop collimator of claim 8, wherein the variable stop is a substantially cylindrical base having a raised spiral projection.

13. The variable stop collimator of claim 8, wherein the variable stop mechanism is configured to move the cylinder such that it causes a coupled leaf to move transverse to the beam plane.

14. In a radiation therapy machine having a radiation source for producing a radiation beam plane directed toward a patient, a variable stop collimator comprising:
a plurality of radiation attenuating leaves;
for each leaf, a pneumatic cylinder operably coupled thereto, the pneumatic cylinder being configured to independently move each leaf;
a variable stop mechanism operably coupled to each pneumatic cylinder, the variable stop mechanism being configured to move the cylinder such that it causes a coupled leaf to move transverse to the beam plane at points between an open and closed state, wherein the variable stop mechanism includes a substantially cylindrical base and a raised member; and
a motor coupled to each variable stop mechanism, the motor being configured to control each variable stop mechanism.
